(19) United States
(12) Patent Application Publication
(10) Pub. No.: US 2002/0159767 A1
(43) Pub. Date: Oct. 31, 2002

(54) Flow heater

(75) Inventors: Allan E. Witt, Lenoir, NC (US); Kenneth Hays, Sturgeon Bay, WI (US)

Correspondence Address: FOLEY & LARDNER, 777 EAST WISCONSIN AVENUE, MILWAUKEE, WI, 53202, US

(73) Assignee: Hatco Corporation

(21) Appl. No.: 10/174,331

(22) Filed: Jun. 18, 2002

Related U.S. Application Data
(63) Continuation-in-part of application No. 09/525,893, filed on Mar. 15, 2000, now Pat. No. 6,428,627.

(51) Int. Cl. H05B 3/16

(52) U.S. Cl. 392/480; 219/543

(57) ABSTRACT

A flow heater for a sink heater or rethermalizing system is disclosed. The flow heater includes a flow tube in fluid communication with a fluid receptacle. The flow tube has a heating element that is in conductive communication with the flow tube and helically encircles the flow tube. Fluid flowing through the flow tube is caused by thermal siphoning effects. The flow heater system may be used for presoaking, soaking, or sanitizing dishware in a sink or for rethermalizing packaged foods.

### REFERENCE TO RELATED APPLICATIONS

This application is a continuation-in-part of U.S. patent application Ser. No. 09/525,893, filed on Mar. 15, 2000 with inventors Allan E. Witt and Kenneth Hays, assigned to Hatco Corporation, and entitled “Flow Heater”.

### FIELD OF THE INVENTION

The invention relates to a rethermalizing heater or sink heater. The rethermalizing heater or sink heater uses a single tube or multiple tubes with external heating elements in thermally conductive contact with the tube or tubes, providing heat transfer to liquid flowing through the tubes. Liquid is circulated through the tubes and into a tank or sink through the process of thermal siphoning.

### BACKGROUND OF THE INVENTION

Recirculation of water, or other liquids, for example cleaning solutions, is a process commonly used in the food industry. For example, recirculation of wash water has been used in dishwashers. In such a recirculating dishwasher, a tank is used as a relatively large reservoir that is filled with a solution of water and detergent for washing. The water and detergent solution is recycled for washing successive racks with a large percentage of the same liquid being recirculated. The liquid is somewhat diluted with fresh rinse water after each cycle. A drain valve is typically located at the bottom of a tank. Further, an overflow may be located near the top of the tank. The fresh water spray system rinses the racks of dishware at the proper time in a cycle, after it has been washed by pumped recirculation of the large volume of wash water. The wash water is typically heated by a heater to maintain water temperature. Often, such a heater is an electrical heating element submerged in the wash water tank. Using a submerged heating element has the disadvantage that lime and other mineral build-up collects on the heating element. Such lime and mineral build-up is difficult to remove without the use of chemicals. Furthermore, if the lime and mineral build-up is not frequently removed, the heating element is subject to failure.

Conventionally, rethermalizing heaters used for reheating of bagged food product or sink heaters used for sterilizing dishware use a two tank system. One tank is used to collect debris from the system. The debris collecting tank has a ball valve drain. The other tank contains the heating element or elements and is separated to avoid sludge or debris from collecting in it. The second tank has a removal cap on a small drain. Frequently, however, the tank having the substantially clean solution gets contaminated when the first debris collecting tank is not sufficiently drained and flushed frequently enough or completely enough. Furthermore, limescale build-up or mineral build-up occurs in the heated tank that is difficult to remove without the use of chemicals. When the heated tank gets contaminated with scale or debris, the unit may malfunction and the heating elements are subject to failure. Such frequent failures create a major service problem and an increase in warranty costs due to failures.

Further, conventional rethermalizing or sanitizing heating systems use pumps to recirculate fluid through the heating element and into a fluid tank. Such pumping systems are plagued with mechanical pump failures and require routine pump maintenance.

Further still, conventional rethermalizing or sanitizing systems may utilize heating elements that are configured to be used with high voltage services, such as services over 100 volts, including but not limited to, services at 480 volts.

Accordingly, there is a need for a rethermalizing heater or sink heater that uses a heating element that is not submerged in the solution. Further, there is a need for a rethermalizing heater or sink heater that utilizes a single tank. Further still, there is a need for a rethermalizing heater or sink heater that is easily cleaned and easily drained. Yet further still, there is a need for a rethermalizing heater or sink heater that does not require the use of chemicals to remove the limescale build up or mineral build up from heating elements. Still further, there is a need for a rethermalizing or sink heater that does not use a mechanical pump for recirculating fluid. Yet further still, there is a need for a flow heater including a thick-film heating element in conductive communication with the flow tube. Yet still further there is a need for a thick-film heater for a flow tube which may be enabled for any voltage services, including but not limited to 120 volts, 208 volts, 240 volts, 380 volts, 415 volts, or 480 volts.

### SUMMARY OF THE INVENTION

An exemplary embodiment of the invention relates to a flow heater system for heating fluid. The flow heater system includes a fluid receptacle and a flow tube in fluid communication with the fluid receptacle. The flow heater system also includes a film heating element in conductive communication with the flow tube.

Another exemplary embodiment of the invention relates to a sink heater configured to heat and recirculate liquid in a sink. The sink heater includes a flow tube having an inlet and an outlet in fluid communication with the sink. The sink heater also includes a film heating element configured to exchange heat with the flow tube. Fluid flow through the tube is caused by convection from the sink into the inlet and out of the outlet into the sink.

Further, an exemplary embodiment of the invention relates to a method for heating liquid in a fluid receptacle. The method includes providing a flow tube in fluid communication with the fluid receptacle. The method also includes providing a fluid in the fluid receptacle. Further, the method includes providing a film heating element in conductive communication with the flow tube. Further still, the method includes controlling current through the film heating element and creating a thermal siphoning effect in the flow tube.

Further still, an exemplary embodiment of the invention relates to a fluid heater configured to heat and recirculate liquid in a fluid receptacle. The fluid heater includes a flow tube having an inlet and an outlet in fluid communication with the fluid receptacle. The fluid heater also includes a heating element configured to exchange heat with the flow tube. Further, the fluid heater includes a flow tube access port provided adjacent the lower most portion of the flow tube and providing access to the interior of the flow tube.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a diagrammatic view of an exemplary embodiment of a rethermalizing or sink heater;

FIG. 2 is a perspective view of a flow heater apparatus;

FIG. 3 is a right side elevational view of a flow heater apparatus;

FIG. 4 is a left side elevational view of a flow heater apparatus;

FIG. 5 is a front elevational view of a flow heater apparatus;

FIG. 6 is a mechanical diagram of an elevational view of a flow heater apparatus heating element;

FIG. 7 is a mechanical diagram of a front elevational view of a sink heater apparatus heating element;

FIG. 8 is an exemplary diagram of a prospective view of a flow heater apparatus including film heating elements;

FIG. 9 is an exemplary depiction of a film heating element disposed on a thermally conductive surface;

FIG. 10 is a cross sectional view of the heating element of FIG. 9 taken along the line 10-10;

FIG. 11 is yet another exemplary embodiment of a flow heater apparatus including film heating elements; and

FIG. 12 is an exemplary cross section of the flow tube of FIG. 8 taken along the line 12-12.

### DETAILED DESCRIPTION OF THE PREFERRED EMBODIMENTS

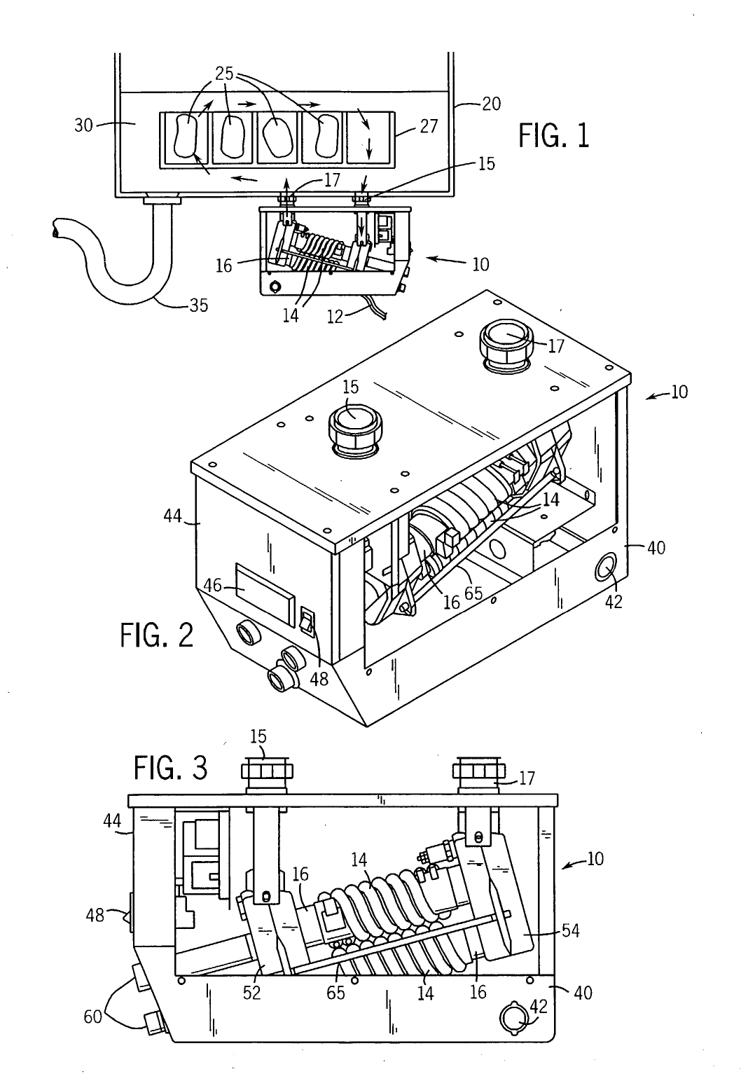

Referring to FIG. 1, a flow heater 10 is coupled to a sink 20, or other fluid receptacle. In an exemplary embodiment, sink 20 may be used as a rethermalizer for reheating packages 25 of prepared food. Packages 25 are held within a rack 27. Rack 27 and packages 25 are submerged in fluid 30, such as, but not limited to, water. A drain 35 may be coupled to sink 20 for complete draining of and cleaning of sink 20.

In an alternative embodiment, sink 20 may hold a rack, similar to rack 27 which is designed to hold dishes. Utilizing a rack holding dishes, flow heater 10 may be used as a sanitizer. Further, sink 20 may be used for a variety of applications, such as but not limited to presoaking or soaking. In an embodiment whereby sink 20 and rack 27 are used as a sanitizer, liquid 30 may be a sanitizing or cleaning solution. Although rack 27 is depicted, sink 20 may be used as a sanitizer without a rack such as rack 27.

In operation, flow heater 10 has electrical connections 12 to at least one heating element 14 of flow heater 10, heating element 14 is wrapped around and in heat conductive contact with a flow tube 16. Cold fluid flows into an inlet 15 at the bottom of sink 20. The cold fluid entering inlet 15 is heated by contact with tube 16 which conducts heat from heating element 14. As the fluid is heated, the fluid moves upward through the angled tube and eventually exits an outlet 17 in the bottom of sink 20. The hotter fluid mixes with fluid 30 in tank 20 and rises to the top. Convection currents drive the colder fluid back into the bottom of sink 20 and into inlet 15, as the process continues.

Referring now to FIG. 2, flow heater 10 is depicted. Flow heater 10 includes heating element 14, encircling a tube 16. Tube 16 has an inlet 15 and an outlet 17. Flow heater tube 16 and heating element 14 are mounted within a flow heater housing 40. Flow heater housing 40 includes an electrical access port 42 for running electrical connections, and a control panel 44 including, but not limited to a control display panel 46 and controls 48, such as, but not limited to, a temperature setting switch and an on/off switch.

As depicted in FIG. 3, inlet 15 may be coupled to an inlet sump 52 to which may be coupled a plurality of flow tubes 16. In a preferred embodiment, flow heater 10 may utilize three flow tubes 16, especially in the case of a three phase power input. However, the design is not limited to the utilization of three tubes, a single tube design may also be used or any number of flow tubes may be applied. Flow tubes 16 are coupled to an outlet sump 54 that is coupled to outlet 17.

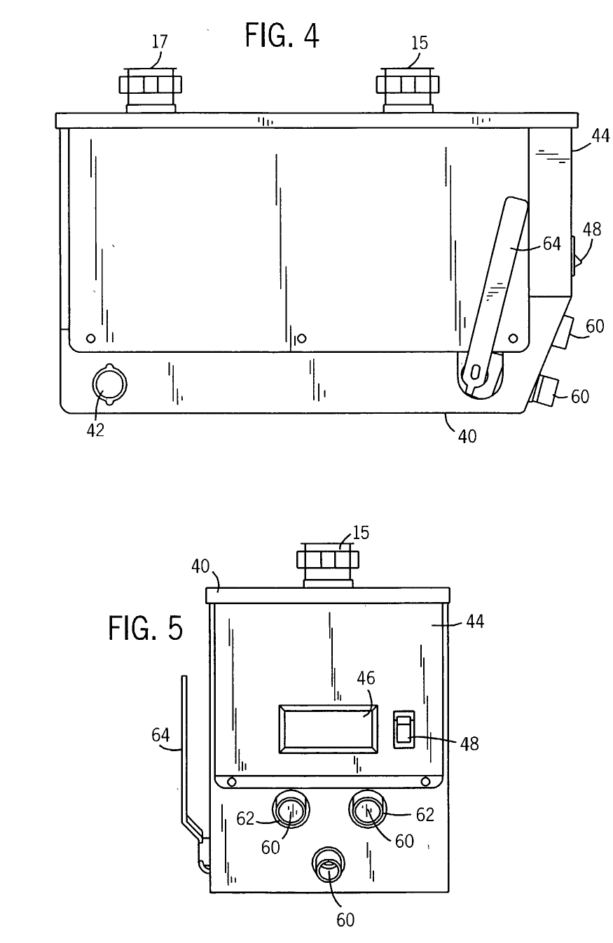

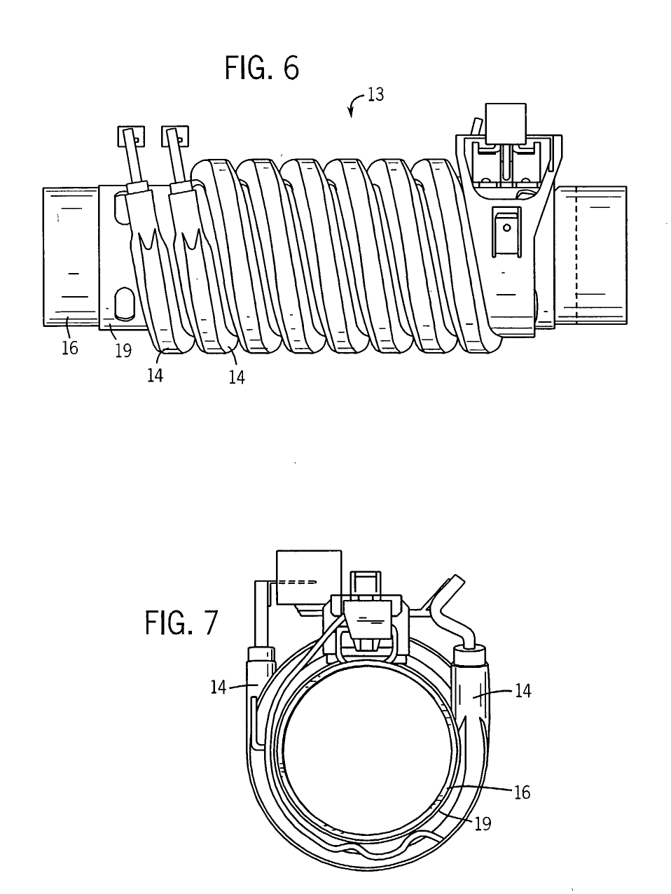

In an exemplary embodiment, flow tubes 16 may have cleaning ports 60 coupled to each of tubes 16. Cleaning or access to ports 60 may have caps 62, such as screw on caps or snap on caps which are preferably removable and seal flow tubes 16. In an exemplary embodiment, an access port 60 or any number of access ports 60 may utilize a valve instead of, or in combination with caps 62. As depicted in the exemplary embodiment of FIGS. 4 and 5, the bottommost access port includes a valve which is operable by a valve handle 64 rotatably mounted on the side of housing 40. Valve handle 64 provides easy access to flow tube 16, that is coupled to the bottommost access port 60, by a simple rotation of valve lever 64. Access port 60 may be used for draining of the flow heater system along with easy access for cleaning. Each of access ports 60 may be utilized for access to tube 16 for cleaning. In order to provide cleaning, an access tube is opened, either by removal of a cap 62, or by operation of valve lever 64. A brush, or other cleaning tool may then be introduced into access ports 60 and further into flow tubes 16, and thereby abrade the inner surfaces of tube 16.

As depicted in FIGS. 6 and 7 an exemplary embodiment of heating element assembly 13 utilized for flow heater 10 is available from Schoeller-Bleckmann Edelstahlrohr of Austria. Heating element assembly 13 includes at least one heating element 14, however, as shown in FIG. 6, multiple heating elements (depicted in FIG. 6 as two heating elements) may be utilized to surround a flow tube 16. Flow tube 16 may be a stainless steel cylindrical tube, as depicted in FIG. 7. As depicted in FIG. 7, flow tube 16 may be a stainless steel tube approximately 1¼ inches in diameter. However, other geometries of flow tubing may be utilized without departing from the spirit and scope of the invention. A conductive sleeve, such as an aluminum sleeve 19, may be in conductive contact with tube 16 to provide improved heat transfer to fluid flowing through tube 16. In an exemplary embodiment, heating element 14 surrounds flow tube 16 in a helical manner. Heating element 14 is furnace braised to flow tube 16 such that stainless tube 16 and aluminum sleeve 19 and spiral heating elements 14 are bonded as a single piece for advantageous heat transfer characteristics. In an exemplary embodiment, heating element assembly 13 provides approximately 95-97 percent efficiency.

In an exemplary embodiment, each heating element assembly 13 can carry up to four kilowatts of energy and may utilize single or three phase power dependent on the number of tubes 16 and heating elements 14. In an exemplary embodiment, flow heater 10 may operate at 12 kilowatts, 240 volts, utilizing three phase power. However, it should be noted that the invention is not limited to the aforementioned efficiencies, power consumption, operating conditions, or inputs.

In an exemplary embodiment, each of tubes 16 has an access port 60 that can be easily accessed with a cleaning brush from the front of housing 40. Each of tubes 16 are connected in parallel to sumps 52 and 54 which, in an exemplary embodiment, are cast aluminum chambers. The chambers may be formed of any of a variety of other materials, such as but not limited to stainless steel, brass, polymers, etc. The chambers are sealed to tubes 16 by flaring the ends of tubes 16 and utilizing an O-ring at each tube end. The entire assembly may be held together by through bolts 65 passing from sump 52 to sump 54 parallel to the tubes and elements (see FIGS. 2 and 3).

Temperature of fluid in fluid receptacle or sink 20 is controlled by a temperature control. Heating element 14 is prevented from being energized without fluid by a low water cut off system. Further, each heating element 14 may have a mechanical safety control built in. In case of dry firing a fusible mechanical safety control device may prevent heating elements 14 from energizing.

Flow heater 10 may be used as a sink heater or a rethermalizing heater where a constant circulation of water at elevated temperatures is desired. In an exemplary embodiment, at 12 kilowatts, 240 volts, the unit will heat about 30 gallons of water with 150° F. temperature rise per hour.

In an alternative embodiment, flow heater 10 may be used in a variety of applications including but not limited to atmospheric water heaters or hot water dispensers. For example, hot water could be maintained in a small tank using flow heater 10 to maintain the liquid contained therein at a relatively constant temperature, for dispensing on command.

As disclosed, flow heater 10 utilizes a flow tube that is tilted with an angle of approximately 5-10 degrees relative to the horizontal. However, it should be noted that flow heater 10 may utilize flow tube 16 at any of a variety of angles from 0° to 90° relative to the horizontal.

Further, in an exemplary embodiment, heating elements 14 are braised on providing direct contact with tubes 16. However, heating elements 14 need not be fixedly attached to tube 16 nor need they be in physical contact with tubes 16. However, differing heat transfer results will be achieved depending on the method of contact. Furthermore, in an exemplary embodiment, heating elements 14 have a substantially flat surface to provide a greater surface area in contact with tube 16. However, the invention is not limited to heating elements with a flat surface.

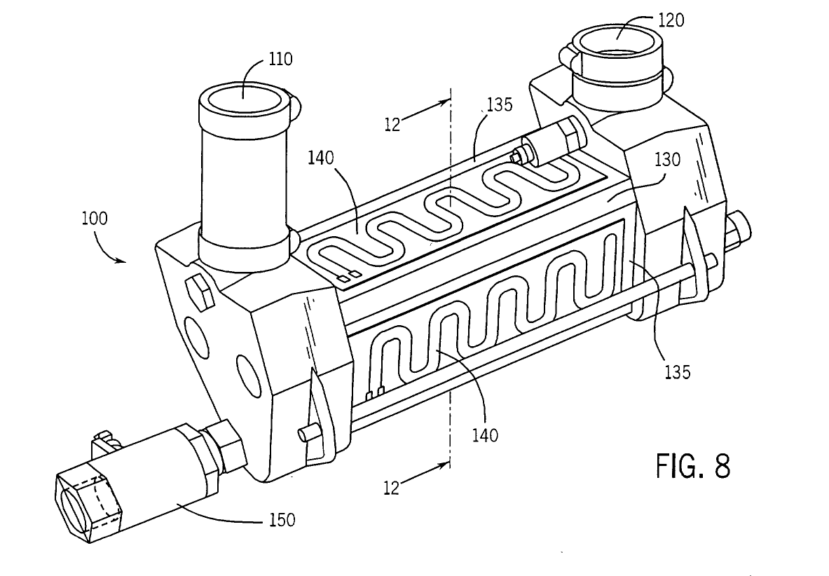

Referring now to FIG. 8, an alternative embodiment of a flow heater apparatus 100 is depicted. Flow heater apparatus 100 includes an inlet 110 and an outlet 120 coupled to a flow tube 130. In an exemplary embodiment, flow tube 130 has an approximately triangular cross section as depicted in FIG. 12. Flow tube 130 may be provided of a variety of materials, including but limited to, stainless steel. Flow tube 130 includes a plurality of surfaces 135 on which a film heating element 140, such as but not limited to, a thick-film heating element is disposed and configured to provide heat to the walls of flow tube 130 and to the liquid flowing through the aperture 138 of flow tube 130.

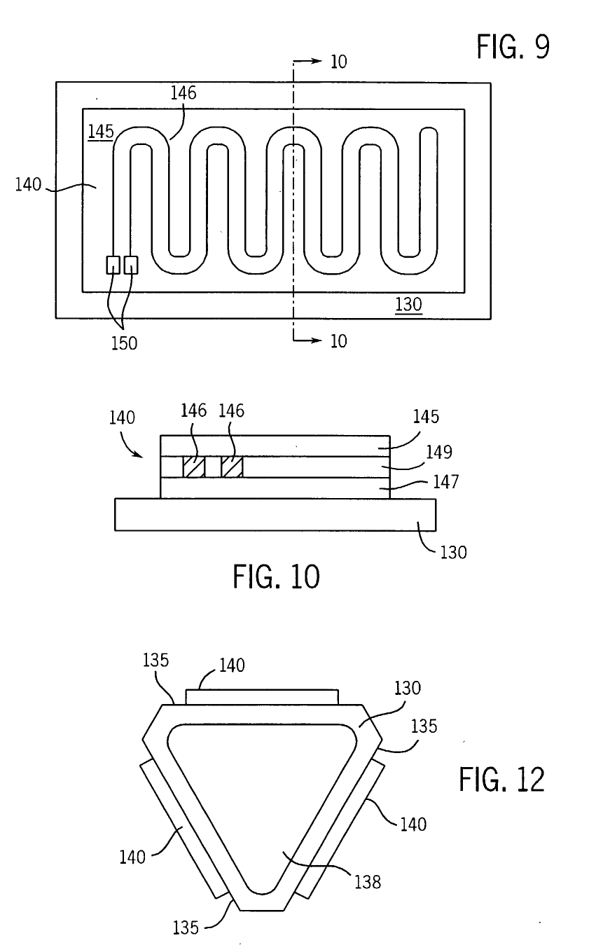

A film heating element, such as thick-film heating element 140 may be a heating element which is silk screened or otherwise disposed onto surface 135 of tube 130. In an exemplary embodiment, thick-film heating element 140, as depicted in FIG. 9, includes an outer insulating layer 145 through which may be viewed, using materials according to a particular embodiment, such as glass, glazes, and some ceramic glazes, a heating element 146 which may be serpentined or otherwise patterned over the surface of a lower dielectric layer 147, see FIG. 10. For example, to produce thick-film heating element 140 on surface 130, a dielectric layer which may be a ceramic, or other materials, may be provided on surface 130 by any of a variety of processes including a variety of deposition processes including silk screening. Next, a patterned conductive and resistive layer 146 may be provided via silk screening or other deposition techniques overlying layer 147. Finally, an insulating layer 145 which may be provided overlying and filling the areas of layer 149 not occupied by resistive areas 146 with any of a variety of insulating materials including glass. Accordingly, a ceramic encapsulated resistor is formed on the surface 130 having two conductive terminals 150 for providing electrical power thereto.

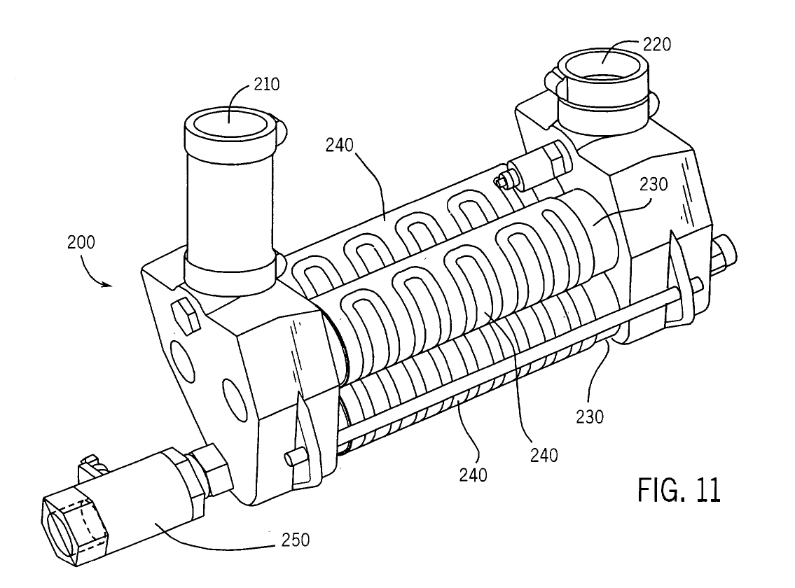

Referring now to FIG. 11, another exemplary embodiment of a flow tube 200 is depicted. Flow tube apparatus 200 includes an inlet 210 and an outlet 220. Flow tube apparatus 200 includes, in an exemplary embodiment, three flow tubes 230 in fluid communication with inlet 210 and outlet 220. Each of flow tubes 230 has a film heater 240 disposed thereon as previously described. In alternative embodiments, flow tubes 230 may have any of a variety of cross sectional geometries, including, but not limited to, circular geometries. Further, flow tube apparatus 200 may include any of the number of flow tubes 230 including, but not limited to, three. An access port 250 is provided at the lower most portion of flow tubes 230 for providing access to the interior of flow tubes 230 and for providing drainage of flow tubes 230.

In an exemplary embodiment, film heating element 240 and 140 may be any of a variety of film heating elements, including thick-film heating elements comprised of a glass overcoat, a resistive glaze, and a dielectric substrate that is bonded to the tube material. In an exemplary embodiment, film heating elements 140 and 240 may be operating at voltages of 240 volts or greater including, 480 volts, as well as other operating voltages both above and below this range. For example, film heaters 140 and 240 may be configured to operate at lower voltages such as, but not limited to, 120 volts. Further, in operation, current is controlled through heating elements 140 and 240 by a control unit in order to provide the proper temperature to the fluid flowing the flow tubes. Further, in an exemplary embodiment, the film heating elements may have any of a variety of dimensions, some but not all being on the order of 1/32nd of an inch thick. Film heating elements 140 and 240 may be manufactured by IRC/TT Electronics of Boone, N.C., and Dekko Heating Technologies of North Webster, Ind., as well as other manufacturers.

While the exemplary embodiments refer to a flow heater for a sink heater or a rethermalizing heater, the present invention may also be applied to other types of recirculating heating systems.

Further, those who have skill in the art will recognize that the present invention is applicable with many different hardware configurations and processes.

While the detailed drawings, specific examples, and particular formulations given describe exemplary embodiments, they serve the purpose of illustration only. The material and configurations shown and described may differ depending on the chosen performance characteristics and physical characteristics of the disclosed devices. For example, the type and capacity of the heating elements used may differ. The systems shown and described are not limited to the precise details and conditions disclosed. Furthermore, other substitutions, modifications, changes, and omissions may be made in the design, operating conditions, and arrangement of the preferred embodiments without departing from the spirit of the invention as expressed in the appended claims.

What is claimed is:

1. A flow heater system for heating fluid, the flow heater system comprising:
a fluid receptacle;
a flow tube in fluid communication with the fluid receptacle; and
a film heating element in conductive communication with the flow tube.

2. The flow heater system of claim 1, wherein fluid flow through the flow tube is caused by thermal siphoning.

3. The flow heater system of claim 1, wherein the film heating element is a thick-film heating element.

4. The flow heater system of claim 1, wherein the film heating element includes three layers.

5. The flow heater system of claim 4, wherein the film heating element includes a resistive layer disposed between a dielectric layer and an insulative layer.

6. The flow heater system of claim 1, wherein the film heating element is bonded to the flow tube.

7. The flow heater system of claim 1, wherein the flow tube includes stainless steel.

8. The flow heater system of claim 1, wherein the film heating element is silk screened to the flow tube.

9. The flow heater system of claim 1, wherein the flow tube has a substantially triangular cross section.

10. The flow heater system of claim 1, wherein the flow tube has a substantially circular cross section.

11. The flow heater system of claim 1, wherein the flow tube is comprised of more than one flow tube.

12. The flow heater system of claim 1, wherein the film heating unit is configured to be operated at voltages of 100 Volts and above.

13. A sink heater configured to heat and recirculate liquid in a sink, comprising:
a flow tube having an inlet and an outlet in fluid communication with the sink; and
a film heating element configured to exchange heat with the flow tube,
wherein fluid flow through the tube is caused by convection from the sink into the inlet and out of the outlet into the sink.

14. The sink heater of claim 13, wherein fluid flow through the flow tube is caused by thermal siphoning.

15. The sink heater of claim 13, wherein the film heating element is a thick-film heating element.

16. The sink heater of claim 13, wherein the film heating element includes three layers.

17. The sink heater of claim 16, wherein the film heating element includes a resistive layer disposed between a dielectric layer and an insulative layer.

18. The sink heater of claim 13, wherein the film heating element is bonded to the flow tube.

19. The sink heater of claim 13, wherein the flow tube includes stainless steel.

20. The sink heater of claim 13, wherein the film heating element is silk screened to the flow tube.

21. The sink heater of claim 13, wherein the flow tube has a substantially triangular cross section.

22. The sink heater of claim 13, wherein the flow tube has a substantially circular cross section.

23. The sink heater of claim 13, wherein the flow tube is comprised of more than one flow tube.

24. The sink heater of claim 13, wherein the film heating unit is configured to be operated at voltages of 100 Volts and above.

25. A method for heating liquid in a fluid receptacle, comprising:
providing a flow tube in fluid communication with the fluid receptacle;
providing a fluid in the fluid receptacle;
providing a film heating element in conductive communication with the flow tube;
controlling current through the film heating element; and
creating a thermal siphoning effect in the flow tube.

26. The method of claim 25, further comprising:
stopping current in the film heating element when liquid flow through the tube is substantially stopped.

27. A fluid heater, configured to heat and recirculate liquid in a fluid receptacle, comprising:
a flow tube having an inlet and an outlet in fluid communication with the fluid receptacle;
a heating element configured to exchange heat with the flow tube; and
a flow tube access port provided adjacent the lowermost portion of the flow tube, providing access to the interior of the flow tube.
